(19) United States
(12) Patent Application Publication
(10) Pub. No.: US 2007/0292236 A1
(43) Pub. Date: Dec. 20, 2007

(54) Screw

(76) Inventors: Jui-Tse Hsieh, Sinshin Township (TW); Chiu-Yueh Wang, Gangshan Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/892,824

(22) Filed: Aug. 28, 2007

Related U.S. Application Data
(63) Continuation-in-part of application No. 11/405,409, filed on Apr. 18, 2006.

(30) Foreign Application Priority Data
Mar. 24, 2006 (TW) 095205011

(51) Int. Cl. F16B 25/10

(52) U.S. Cl. 411/387.1

(57) ABSTRACT

The present invention pertains to a screw comprising an enlarged head and a shank with threads. In particular, the enlarged head has a bottom surface comprising a plurality of ribs extended from the outer periphery thereof to the shank, thereby providing with a good resistance of extraction and a good waterproof effect. Additionally, due to the ratio of the outer diameter of the shank to the outer diameter of the head being 1:3.5˜5.5, the debris extruded out of the object hence can be covered and squeezed beneath the enlarged head, so as to maintain a clean appearance.

### CROSS-REFERENCE TO RELATED APPLICATION

This application is a continuation-in-part of the U.S. patent application Ser. No. 11/405,409 filed on Apr. 18, 2006.

### BACKGROUND OF THE INVENTION

1. Field of the Invention

The present invention relates to a screw, in particular a screw having an enlarged head which comprises a bottom surface with a plurality of ribs arranged thereon, thus ensuring a good resistance of extraction, simultaneously providing with the waterproof effect and maintaining a clean appearance.

2. Description of the Related Art

Referring to FIG. 1, a conventional screw 1 of the U.S. Application No. 2005/0226701 comprises a head 11, a shank 12 with a plurality of threads 13 disposed thereon, and a knurling portion 14 disposed between the head 11 and the threads 13; wherein, the head 11 comprises a bottom surface 111 defined at the underside thereof and a neck portion 112 extended from the bottom surface 111 to the shank 12; the head 11 having a larger diameter than that of the shank 12. A plurality of ribs 113 are disposed on the bottom surface 111, and part of the ribs 113 are extended to the neck portion 112; further, a ring 114 is formed along the circumference of the bottom surface 111. A drilling tip 121 is formed at the end of the shank 12.

Referring to FIGS. 2 and 3, a conventional screw 2 of the U.S. Pat. No. 4,518,294 comprises a head 21, a shank 22 extended from the head 21, and a plurality of threads 23 disposed on the shank 22; wherein, the head 21 comprises a bottom surface 211 defined at the underside thereof, where a helical rib 212 is disposed thereon. The helical rib 212 extends outwardly from the shank 22 and terminates at an outer boundary 213 of the head 21.

However, there are still some defects with regard to the above conventional screws:

1. Smaller Screw Head

Generally, the screw 1 comprises the head having a larger diameter than that of the shank, and the ratio of the outer diameter of the shank to the outer diameter of the head is normally arranged as 1:2, which reveals that the head has relatively less area to make the debris of the object covered and squeezed beneath the head, which results in the debris easily extruded to the surface of the object and in an untidy appearance after screwing.

2. Infiltration of the Water

Due to the ejected debris, the bottom surface of the head is unable to fully contact with the surface of the object, which easily causes the water seeped into the space between the bottom surface and the surface of the object while screwing. Accordingly, the ribs may be disposed on the bottom surface to overcome the above problem; however, the ribs formed in a helical state as shown in FIG. 3 may preferably increase the screwing torque, instead of ensuring a good contact with the surface of the object, therefore the screw 2 may not effectively block the infiltration of the water.

### SUMMARY OF THE INVENTION

It is an object of the present invention to provide a screw having an enlarged head with a plurality of ribs defined at the bottom surface thereof, thereby aiding the screw in being firmly screwed into the object and being impervious to water, so as to achieve the waterproof effect.

Another object of the present invention is to provide a screw with an enlarged head among the specific ratios, thereby covering the debris extruded out of the object to maintain a clean appearance.

The screw in accordance with the present invention comprises an enlarged head, a shank with threads and a drilling portion, and a conical section. In Particular, the ratio of the outer diameter of the shank to the outer diameter of the head is 1:3.5˜5.5, whereby the screw has a broad area to cover the debris of the object for keeping a clean appearance. Additionally, the enlarged head has a bottom surface with a plurality of ribs arranged thereon, thereby providing with a good resistance of extraction and the waterproof effect after screwing.

The advantages of the present invention over the known prior art will become more apparent to those of ordinary skilled in the art upon reading the following descriptions in conjunction with the accompanying drawings.

### BRIEF DESCRIPTION OF THE DRAWINGS

FIG. 1 is a schematic view showing a conventional screw of the U.S. Application No. 2005/0226701;

FIG. 2 is a schematic view showing a conventional screw of the U.S. Pat. No. 4,518,294;

FIG. 3 is a bottom view showing the bottom view of the screw head in the conventional screw of the U.S. Pat. No. 4,518,294;

FIG. 4 is a perspective view showing a screw of the first preferred embodiment of the present invention;

FIG. 5 is a schematic view showing the screw of the first preferred embodiment screwed into the object;

FIG. 6 is a perspective view showing a screw of the second preferred embodiment of the present invention;

FIG. 7 is a schematic view showing the screw of the second preferred embodiment screwed into the object; and

FIG. 8 is a perspective view showing a screw of the third preferred embodiment of the present invention.

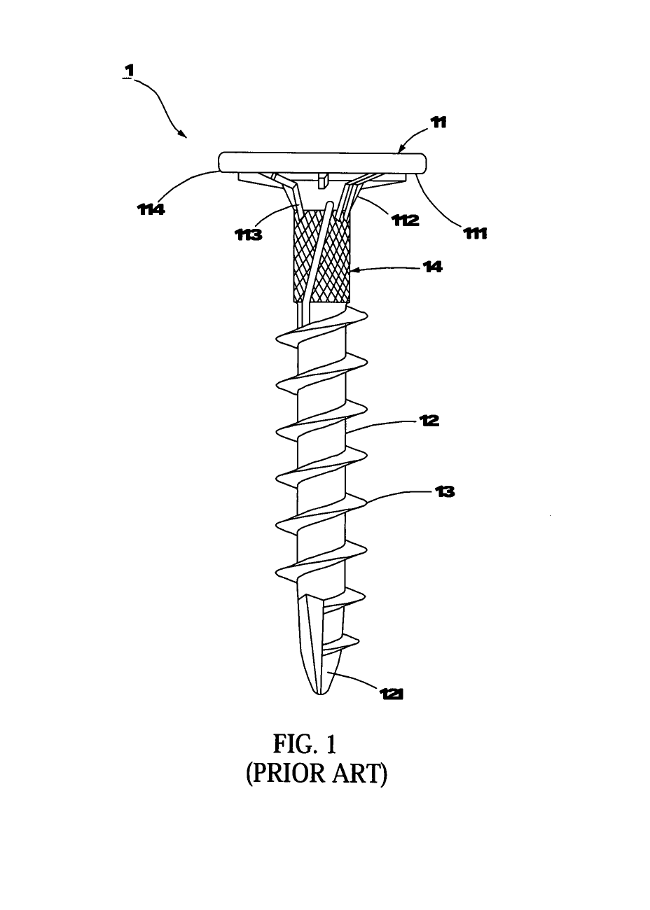

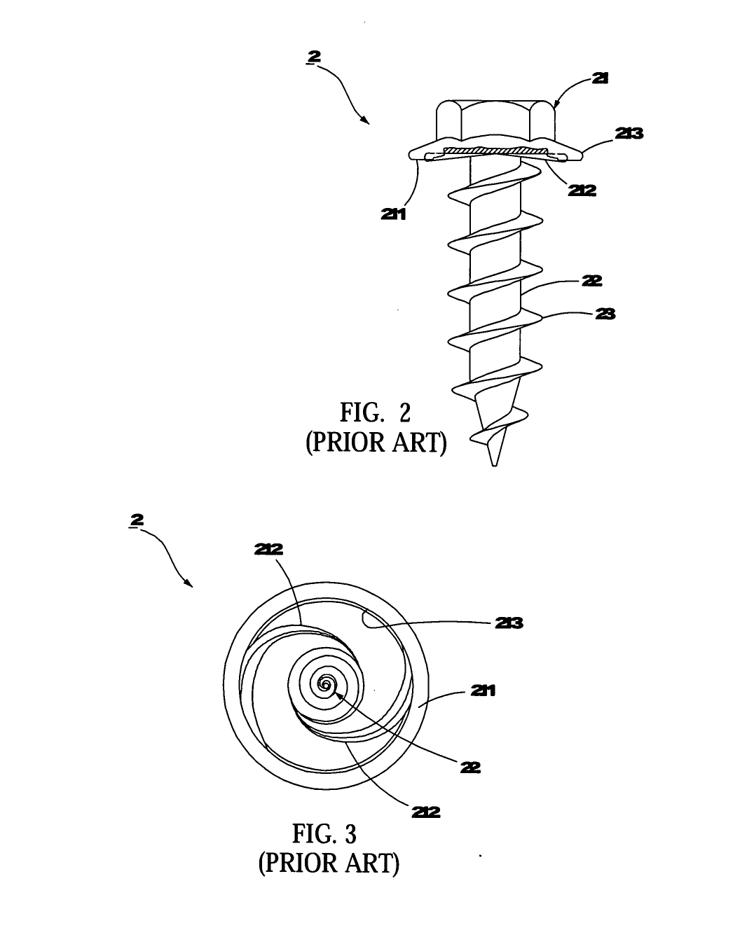

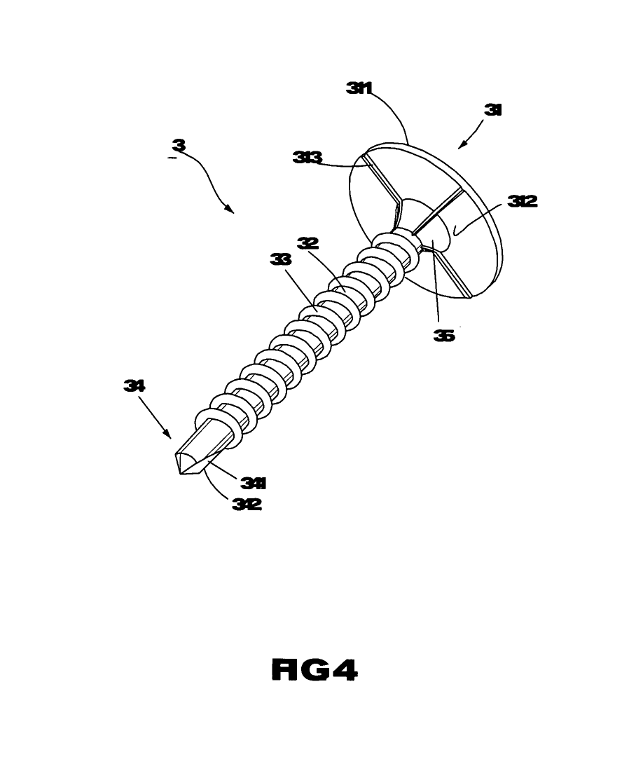

### DETAILED DESCRIPTION OF THE PREFERRED EMBODIMENTS

Before the present invention is described in greater detail, it should be noted that the similar elements are denoted by the same reference numerals throughout the disclosure.

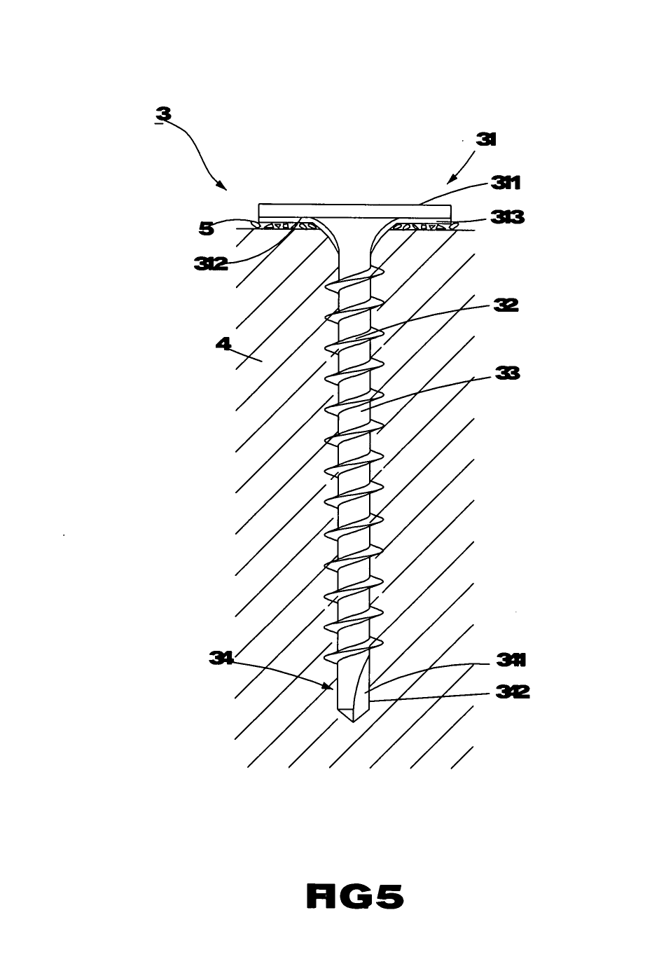

Referring to FIG. 4, the screw 3 of the first preferred embodiment comprises an enlarged head 31, a shank 32 longitudinally extended from the head 31, and a conical section 35 extended from the head 31 in contact with the shank 32; wherein, the enlarged head 31 comprises an upper surface 311 and a bottom surface 312 defined opposite thereto; the bottom surface 312 has a plurality of rids 313, which are extended from the outer periphery of the bottom surface 312, across the conical section 35 and terminated in contact with the shank 32; the ratio of the outer diameter of the shank 32 to the outer diameter of the head 31 is 1:3.5˜5.5, and the ratio 1:3.5 is adopted in this preferred embodiment. Additionally, the shank 32 has a plurality of threads 33 disposed thereon and a drilling portion 34 formed at a distal end thereof; at least one cutting groove 341 is formed on the drilling portion 34, and a cutting edge 342 is defined on the outer edge of the drilling portion 34, connecting to one side of the cutting groove 341

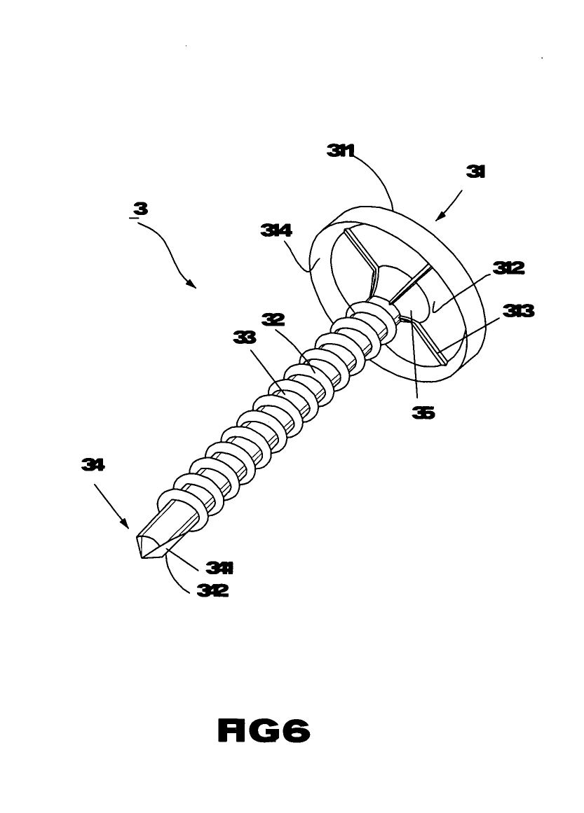

As shown in FIG. 5, during the operation, the operator initially transfers a force on the screw 3 to rotate the head 31, which drives the drilling portion 34 to be drilled into the object 4. Subsequently, the debris 5 generated from the object 4 is extruded to the surface thereof and is covered by the enlarged head 31 to maintain a clean appearance. Simultaneously, the ribs 313 arranged on the bottom surface 312 of the head 31 closely contact with the surface of the object 4, and which facilitates to ensure a good resistance of extraction and to prevent the water from seeping into the space between the bottom surface 312 and the surface of the object 4, thus decreasing the rustiness of the screw 3.

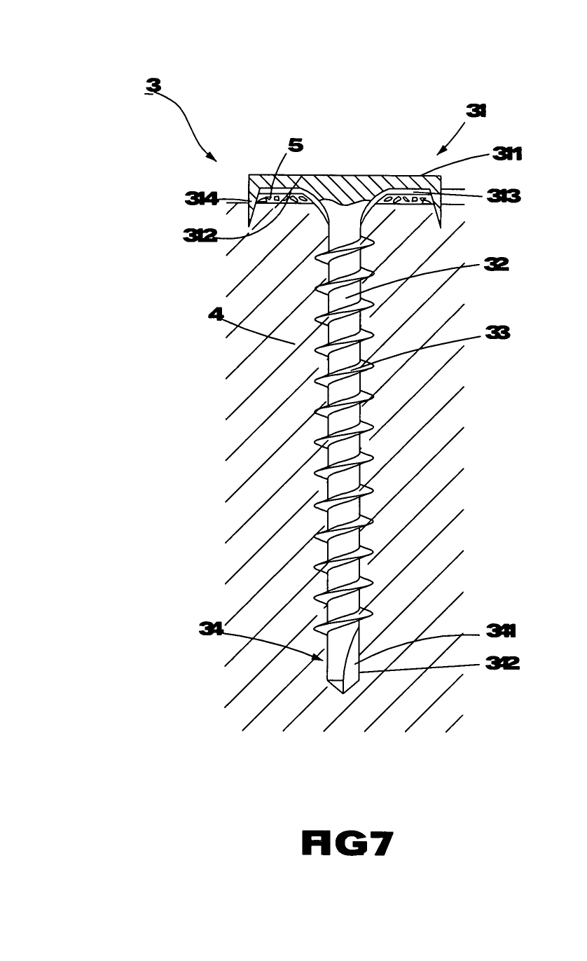

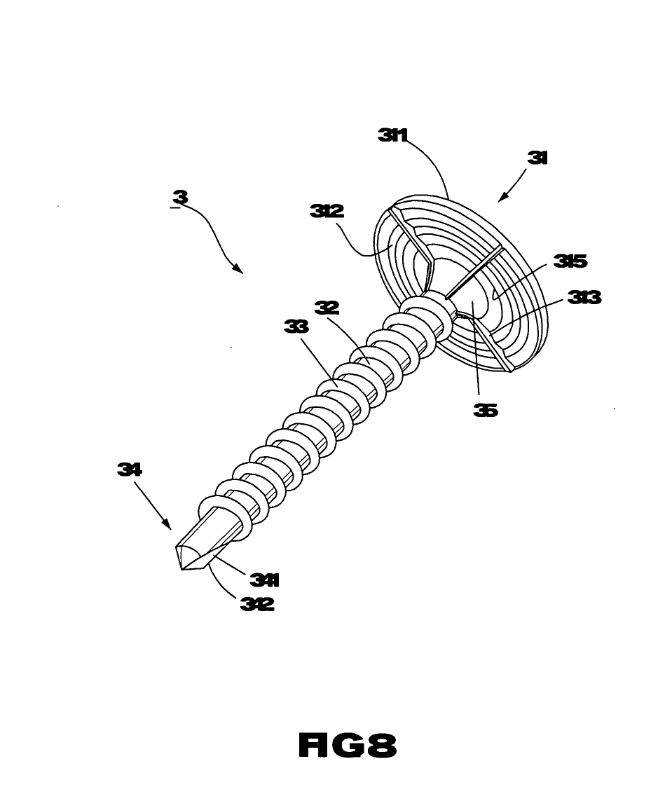

Referring to FIG. 6, the screw 3 of the second preferred embodiment comprises a head 31, a shank 32 with threads 33 and a drilling portion 34, and a conical section 35; the composition of the elements and the operation are the same as the first preferred embodiment. Notably, the bottom surface 312 has a cutting ring 314 formed around the outer periphery thereof, which provides with a sharp end. Further referring to FIG. 7, while in screwing, the cutting ring 314 proceeds to cut the circumference of the surface of the object 4 and makes the screw 3 firmly screwed to the object 4, so as to prevent the undesired destruction of the object 4.

As referring to FIG. 8, the screw 3 of the third preferred embodiment still has the similar elements and the same operation as the first preferred embodiment. Particularly, a plurality of annular ribs 315 disposed on the bottom surface 312 of the head 31 is formed as a state of the concentric circles. By means of the annular ribs 315 and the ribs 313, the bottom surface 312 of the screw 3 closely contacts with the surface of the object 4, so as to block the infiltration of water for enhancing the waterproof effect.

To sum up with the above descriptions, the present invention provides with the following advantages:

1. Maintaining a Clean Appearance

Due to the ratio of the outer diameter of the shank to the outer diameter of the head being 1:3.5˜5.5, the debris generated from the object hence can be covered and be squeezed beneath the broad area of the enlarged head, so as to keep a clean appearance.
   2. Ensuring a Waterproof Effect and a Good Resistance of Extraction
By means of the enlarged head with ribs arranged on the bottom surface thereof and the configuration of the annular ribs, the screw closely contacts with the surface of the object, thereby keeping a good resistance of extraction and blocking the water to result in less possibility of the rustiness on the screw.
   3. Decreasing the Undesired Destruction of the Screw
Due to the cutting ring with a sharp end, the enlarged head is able to be firmly screwed into the object without increasing the destruction of the surface of the object.

To sum up, the present invention takes advantage of the ratio of the outer diameter of the shank to the outer diameter of the head being 1:3.5˜5.5 and accompanying with the ribs disposed at underside of the enlarged head, which are conducive to maintain a clean appearance, to achieve a good resistance of extraction, and to increase the waterproof effect after screwing.

While we have shown and described the present invention with reference to the specific preferred embodiment, it should be clear to those skilled in the art that further embodiments may be made without departing from the scope of the present invention.

I claim:

1. A screw comprising:
an enlarged head having an upper surface defined thereon and a bottom surface opposite to said upper surface;
a shank longitudinally extended from said bottom surface of said enlarged head; wherein, said shank including a plurality of threads axially disposed thereon and a drilling portion formed at a distal end thereof; the ratio of the outer diameter of said shank to the outer diameter of said head being 1:3.5˜5.5;
a conical section defined on said bottom surface; said conical section connecting said enlarged head and said shank; wherein, said bottom surface having a plurality of ribs radially arranged thereon, which are extended from the outer periphery of said bottom surface, across said conical section and terminated in contact with said shank.

2. The screw as claimed in claim 1, wherein said bottom surface comprises a cutting ring formed around the outer periphery thereof; said cutting ring provides with a sharp end.

3. The screw as claimed in claim 1, wherein said bottom surface has a plurality of annular ribs disposed thereon.
